(19) United States
(12) Patent Application Publication
(10) Pub. No.: US 2025/0353710 A1
(43) Pub. Date: Nov. 20, 2025

(54) BRAKING SYSTEM AND METHOD FOR BRAKING WITH VARIABLE BRAKING FORCE

(71) Applicant: RINGSPANN GmbH, Bad Homburg (DE)

(72) Inventor: Martin Alexander Ohler, Frankfurt (DE)

(73) Assignee: RINGSPANN GmbH, Bad Homburg (DE)

(21) Appl. No.: 18/872,918

(22) PCT Filed: Jun. 20, 2023
(86) PCT No.: PCT/EP2023/066604

§ 371 Date: Dec. 9, 2024

(30) Foreign Application Priority Data
Jun. 23, 2022 (DE) 10 2022 115 657.5

(51) Int. Cl. B66D 5/26

(52) U.S. Cl. CPC B66D 5/26

(57) ABSTRACT

A braking system (3), in particular emergency braking system, in a drive unit, which drive unit includes at least one motor (8) and at least one unit (6) driven by the motor (8). The braking system has: a plurality of controllable brakes (16a-16b), which are arranged and designed to act on the drive unit; and a controller (12), which is designed to preselect and accordingly pilot-control a number of brakes (16a-16b) from amongst said plurality of brakes (16a-16b) depending on a state or load situation of the drive unit, so that, when the braking system (3) is activated, the drive unit can be acted on only by way of said preselected number of brakes (16a-16b).

### CROSS-REFERENCE TO RELATED APPLICATIONS

This application is a 371 National Phase of PCT/EP2023/066604, filed Jun. 20, 2023, which claims priority to German Patent Application Number 10 2022 115 657.5, filed Jun. 23, 2022, both of which are incorporated herein by reference as if fully set forth.

### TECHNICAL FIELD

The invention relates to a braking system, in particular an emergency braking system, in a drive unit.

The invention further relates to a crane or a gantry crane or a comparable device which is equipped with a braking system according to the invention.

The invention also relates to a method for braking with variable braking force in a drive unit.

### BACKGROUND

Overdesigned brakes, in particular—but not exclusively—on the transmission output side of a drive unit may lead to unpredictable damage to and malfunctions in drive systems, in particular of transmissions and steel structures. Since, for example in cranes, the moving loads and the associated travel speeds are continuously changing, brakes are overdesigned in terms of the actually required braking force in many travel situations. A relevant cause is that both the maximum possible load and also the associated travel speed of the system in question are specified with conservative safety margins for the design of the brakes. Consequently, the brakes are simply too powerful for many applications.

In the case of relatively large drive trains, as are used in steel mill cranes or stacking cranes in container ports for example, the main drive system consists of a motor, a transmission and a cable drum on the transmission output side. These drive units are equipped with brakes on the motor and transmission output side in order to increase operational safety. For this purpose, the brake design is based on lifting gear data (for example a maximum permissible weight beneath the hook and/or a maximum permissible travel speed) and a safety margin. In order to ensure safety in every operating state, this design is made assuming a worst-possible operating situation—that is to say overload at excess rotation speed. However, since a load situation of this kind is rare or does not occur at all during actual, everyday operation, the brakes are correspondingly overdesigned in the vast majority of cases.

In the event of emergency stopping, in the case of which all existing brakes are applied or activated irrespective of the current travel situation, extremely high force and torque peaks briefly act on the drive unit, in particular on the transmission and the transmission components, such as transmission gears for example, and also on a structure holding the drive unit, for example the steel structure of a crane, owing to this overdesign. This situation is further exacerbated in that, owing to the design, brakes for a cable drum or a comparable driven unit, which brakes are generally actuated by what are known as plate springs, can close more rapidly than additionally existing brakes on the rapidly rotating motor side, which additional brakes are generally actuated by helical springs. Owing to this circumstance, the entire drive train on the transmission output side locks, whereas owing to the mass inertia of the rotating drive elements (clutches, brake disk, motor shaft etc.) forces are yet further disadvantageously introduced into the transmission already locked by the emergency stopping brakes.

Excessively powerful braking also results in unpredictable force peaks in the (steel) support assembly of the overall system, and these force peaks can have a negative effect on the service life of the support assembly.

### SUMMARY

The invention is based on the object of remedying this and specifying a braking system and, respectively, a method for braking with variable braking force, which braking system avoids the abovementioned disadvantages and in this way contributes to protecting the drive system and its individual constituent parts together with a support assembly accommodating the drive system in order to in this way extend the service life of the system and to reduce costly maintenance work.

According to the invention, this object is achieved by a braking system having one or more of the features disclosed herein, by a crane or a gantry crane having one or more of the features disclosed herein, and also by a method for braking with variable braking force having one or more of the features disclosed herein.

Advantageous developments of the system according to the invention are defined below and in the claims.

A braking system according to the invention, in particular an emergency braking system, in a drive unit, which drive unit comprises at least one motor and at least one unit driven by the motor, has: a plurality of controllable brakes, which are arranged and designed to act on the drive unit; a controller, which is designed to preselect and accordingly pilot-control a number of brakes from amongst said plurality of brakes depending on a state or load situation of the drive unit, so that, when the braking system is activated, the drive unit can be acted on only by way of said preselected number of brakes.

A method according to the invention for braking with variable braking force in a drive unit, which drive unit comprises at least one motor and at least one unit driven by the motor, comprises: a) providing a plurality of controllable brakes, which are arranged and designed to act on the drive unit, and thus a corresponding braking system; b) determining a state or load situation of the drive unit; and c) making a preselection of a number of brakes from said plurality of brakes by means of a controller depending on the determined state or load situation, which preselection, owing to corresponding pilot control of the brakes, has the effect that, when the braking system is activated, the drive unit can be acted on only by way of said preselected number of brakes.

In order to counteract said circumstances, the objective of the braking system (or for short: system) described here is to pre-emptively identify or determine the load and/or travel speed, in particular in the case of a crane or a winch, and to adapt the braking power in advance depending on the situation by preselecting the brakes to be closed or activated in the event of an emergency. As a result, force and torque peaks as well as or in particular in the transmission and also force peaks on the surrounding supporting structure in particular of the crane or the winch can be reduced.

The basic idea of the braking system or method according to the invention is to prevent excessively powerful braking by preselecting the brakes and/or braking force. This is achieved by switching on or switching off the brakes during the course of said preselection. The brakes can advantageously be correspondingly actuated via a dedicated controller, provided for this purpose, of the braking system. However, as an alternative, the brakes can also be actuated directly by a controller of the drive unit, in particular a crane or winch controller, that is generally present in any case. The effect on the drive unit or the crane or the winch is the same in both cases: to act with the appropriate braking force in accordance with the determined state or load situation, for example a specified load and/or (travel) speed.

It is exactly the same with the load measuring pins discussed more precisely further below, these load measuring pins representing a possible configuration for determining the state or load situation. With respect to the mere functional principle, these load measuring pins can be provided, for example, by the crane manufacturer or by the winch manufacturer; the dedicated controller mentioned then uses the corresponding signal to make a decision in respect of said preselection. As an alternative, the crane or winch controller itself can in turn be designed to make the decision in respect of the preselection of the brake configuration.

It is also possible within the scope of the invention for the decision in respect of the brake configuration or the preselection to be made by predefining different load situations. For example, predefining a “load situation 1” can include a crane having a high travel speed and a very low load in the travel mode “without load”. In contrast, a predefined “load situation 2” can include a medium load and a medium travel speed (travel mode “medium load”). In this case, for example, the use of a sensor unit, such as a load measuring pin, would no longer be absolutely necessary for determining the state since a preselection of the travel situation or the state or the load situation by the relevant signal “crane/winch in travel mode X” can already be used for preselecting the brakes. The desired effect on the described braking system, specifically braking with braking force matched to the load situation, would also be advantageously achieved here.

A first development of the braking system according to the invention includes a sensor arrangement, which is designed to determine the state or load situation of the drive unit, having at least one relevant sensor unit, which provides a corresponding sensor signal; wherein the controller is operatively connected in a signal-transmitting manner to the sensor unit and wherein the load situation of the drive unit can be determined depending on the sensor signal or the sensor signals.

A corresponding development of the method according to the invention provides that the state or load situation is determined by means of a sensor arrangement having at least one relevant sensor unit, which provides a corresponding sensor signal, depending on the sensor signal or the sensor signals, for which purpose the controller is operatively connected in a signal-transmitting manner to the sensor unit.

The preselection is preferably made here by interaction of load measuring pins (or a comparable (sensor) device for detecting a moving load), encoders (or comparable (sensor) devices for monitoring rotational or travel speeds) and a logic controller or controller, which controller has available the measurement data of said devices for detecting the load or monitoring the rotational/travel speed. The controller may be—as already mentioned—a dedicated controller of the braking system or a controller of the drive unit, for example of a crane or a winch, that is generally present in any case.

The encoder does not have to be a dedicated constituent part of the brake system, but rather can also already be provided by the crane/winch manufacturer.

If, as described more precisely further below, latching valves are used for preselecting the brakes, these retain their position (setting) even in the event of a power failure, as occurs, for example, in a “conventional” emergency-off situation. However, in a corresponding development of the invention, it is also possible to provide an interruption-free power supply (for short “USV”—in principle a battery which can continue to supply power to selected components over a certain period of time) in combination with an encoder and a controller in order to monitor (undesired) movements of the drive unit and if appropriate to subsequently switch on or switch off, for example, further brakes in the event of set braking values being exceeded/undershot. This would also be possible during the course of the last-mentioned refinement when the power supply was interrupted by an emergency-off operation.

The controller advantageously controls valves or comparable devices, which predefine the number and power of the emergency stop brakes in accordance with the load situation, on the basis of the abovementioned, physically detected values (force and/or speed).

In a corresponding refinement of the invention, such valves have the special feature, even in the event of a power cut or an emergency-off switch being pressed, of not changing their predefined position, in order to in this way prevent excessively powerful braking by (in a given case possibly unnecessarily) closing all the brakes.

Here, the encoders or the like advantageously help in the sense of a redundant system to detect the actual movements within the drive train. Owing to the comparison of desired and actual values in the controller, a control signal can thus be provided if required, which control signal has the effect of opening further valves, so that in the event of an emergency further brakes can be closed and a potentially catastrophic load discharge can be avoided. As a result, the proposed system structure can meet the requirements of a self-controlling system in a corresponding refinement.

The following refinements or developments of the braking system according to the invention have proven particularly advantageous in practice.

In a first development of the braking system according to the invention, it is provided that the drive unit has a transmission, which is operatively connected to the motor, and the driven unit, that is to say a cable drum for example, is arranged on an output side of the transmission. Such a transmission allows a rotational movement of the motor to be transmitted to the driven unit with a certain step-up or step-down ratio, this considerably increasing the possible applications of the system according to the invention.

Another development of the braking system according to the invention provides that the brakes are designed and arranged to act on the driven unit. In this way, the driven unit can be braked in a targeted and direct manner in the event of an emergency. However, it is within the scope of the invention to design or arrange the brakes to also or even only act on the motor.

An extremely advantageous development of the braking system according to the invention provides that the preselected number of brakes comprises at least one brake, a subgroup of all the brakes or all the brakes. In this way, stepped adaptation of the braking force to an actual operating situation is possible by corresponding combination of individual brakes. If there are, for example, two brakes, these can be used either individually or else in combination.

It has proven to be particularly advantageous in practice if, in a corresponding development of the braking system according to the invention, the determined state of the drive system includes at least one of the following variables: a state of the motor, in particular a rotational speed of the motor, a speed of the driven unit, in particular a rotational or travel speed, and/or a load acting on the driven unit or transported by the driven unit. The actual operating situation can be particularly readily and reliably determined in this way.

It has already been pointed out that, in a particular development of the braking system according to the invention, the sensor unit is in the form of an encoder arranged on the motor, on the driven unit and/or on the transmission, and/or that the sensor unit is in the form of a load measuring pin. Devices of this kind have proven to be usable in a particularly reliable and cost-effective manner in practice.

In a particular development of the braking system according to the invention, it can be provided that the driven unit is in the form of a cable winch or a cable drum with a cable which is wound or can be wound onto it. Cable winches or cable drums of this kind are used, in particular, in cranes or gantry cranes, this being a preferred use of the braking system according to the invention.

In a corresponding development of the braking system according to the invention, it can accordingly also be provided that the abovementioned load measuring pin is operatively connected to the likewise abovementioned cable. In this way, the moving load can be reliably determined, in particular in the case of cranes, gantry cranes or the like.

An extremely advantageous development of the braking system according to the invention provides that at least one of the brakes is in the form of a hydraulically or pneumatically actuable brake, preferably in the form of a spring-actuated, hydraulically or pneumatically ventilated brake. Brakes of this kind are particularly well suited to implementing the braking system according to the invention or the method according to the invention.

In a corresponding development of the braking system according to the invention, it can therefore also be provided that the at least one brake comprises at least one latched valve means or switching valve with a latching function. Valve means of this kind are distinguished—as already mentioned further above—in that they can also retain a preselected or pilot-controlled state when, for example, there is a power cut or an emergency-off switch is actuated.

In another development of the braking system according to the invention, it is also possible to make double return from a respective brake to the (hydraulic fluid) tank selectable by way of the latching valves. When return 1 is selected, the brake closes immediately. When return 2 is selected, a throttle or aperture for delayed closing can be used.

The question of whether a brake is completely removed from a braking process, that is to say is deactivated, or whether it is applied by a throttled fluid return only when the actual (emergency) stopping process is complete is not important for the system according to the invention. This is because, irrespective of whether a brake is not applied at all or is applied only with a delay, only that braking force which was correspondingly preselected is introduced into the transmission and drive train in accordance with the load situation or the actual travel situation.

A particularly advantageous development of the braking system according to the invention can also provide that the valve means or switching valve is pilot-controlled or can be pilot-controlled by the controller. The advantages associated with this have already been pointed out in detail further above. The pilot control can be performed—as already mentioned—selectively by a dedicated controller of the braking system or by an already existing winch or crane controller.

Another development of the braking system according to the invention, in which the valve means or switching valve is a 2/2-way valve, preferably a 2/2-way poppet valve, has proven to be particularly advantageous in practice.

In order to be able to reproduce as many different operating situations as possible with the braking system according to the invention, another advantageous development further provides that at least some of the brakes are designed to generate different contact-pressure forces or braking forces. In this way, stepped braking forces, which can be adapted to a respective operating situation, can be realized by skillful combinations of different brakes.

### BRIEF DESCRIPTION OF THE DRAWINGS

Further properties and advantages of the invention can be found in the following description of exemplary embodiments with reference to the drawing.

FIG. 1 shows a schematic overall illustration of a crane having a braking system according to the invention;

FIG. 2 shows a detailed illustration of individual elements of the braking system from FIG. 1; and

FIG. 3 shows an alternative refinement of the braking system according to the invention.

### DETAILED DESCRIPTION

Identical reference signs denote the same or at least similarly acting elements in all the figures.

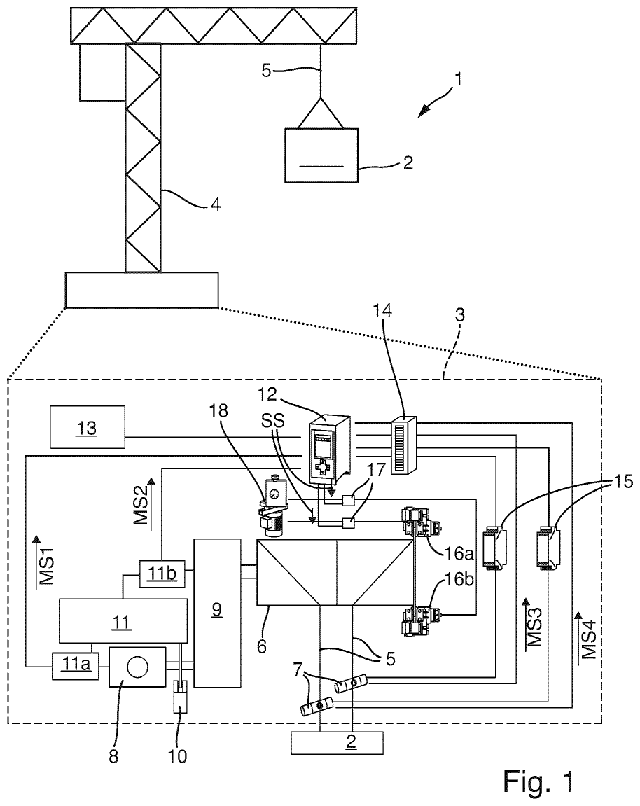

FIG. 1 schematically shows a crane 1 with a load 2, which crane 1 has a braking system 3 according to the invention, which braking system 3 is symbolized in FIG. 1 by a rectangle drawn using dashed lines.

The upper part of FIG. 1 schematically shows the crane 1 together with the load 2 in a simplified manner. The crane 1 has a supporting structure 4, which is preferably formed from steel or a comparable material. The load 2 hangs from a cable 5, which cable 5 can be wound up and unwound by means of a cable drum 6 (see the lower part of FIG. 1) in order to raise and, respectively, lower the load 2.

According to the illustration in the lower part of FIG. 1, the load 2 can also be suspended from more than one cable 5, without the invention being restricted in this respect. The cable 5 or the cables 5 is or are operatively connected to a (respective) load measuring pin 7, the functioning of this load measuring pin 7 being discussed more precisely further below.

In order to drive the cable drum 6, which thus represents a driven unit in the context of the invention, a motor 8 is provided, which motor acts on the cable drum 6 via a transmission 9. A (service) brake 10 is arranged between the motor 8 and the transmission 9 on the output side of the motor 8, which brake can be used to brake a drive movement of the motor 8 for service braking but also in the event of an emergency.

Reference sign 11 denotes an encoder device, which has two encoders 11a, 11b, which encoders 11a, 11b are designed and provided to detect a state of the drive unit, here a rotational speed of the motor 8 or of the transmission 9, and to output a corresponding sensor or measurement signal MS1, MS2. These measurement signals are passed on to a programmable, dedicated controller of the braking system, which controller is represented by reference sign 12 and is operatively connected in a signal-transmitting manner to the encoders 11a, 11b. The controller 12, for its part, is operatively connected in a signal-transmitting manner to an additional, generally present crane controller 13 which, in the exemplary embodiment described here, is provided only for controlling further functions of the crane 1 outside the braking system 3 described here.

However, it has already been pointed out that, in an alternative refinement, the crane controller 13 can be allocated a role comparable to that of the controller 12, and therefore the controller 12 can then be dispensed with in principle.

The controller 12 interacts in a signal-transmitting manner with the abovementioned load measuring pins (LMB) 7 via an analog input module 14 (an A/D converter) or via a respective safety relay 15. The measuring pins preferably output a signal between 4 and 20 mA—the measuring range (the range of the possible loads) can be defined in the lifting gear data of the crane 1. In this way, the controller 12 receives, in addition to the abovementioned measurement signals MS1, MS2 from the motor 8 and the transmission 9, yet further measurement or sensor signals MS3, MS4 from the load measuring pins 7, which further measurement signals MS3, MS4 likewise serve to determine a current operating state of the drive unit.

In principle, the signal cables of the load measuring pins may be damaged, and a measurement error may occur. The load measuring pins 7 therefore preferably have two output channels. The two output signals of a load measuring pin 7 are fed separately one directly into the input module 14 and one through the relevant safety relay 15 into the input module 14. A check is then made in respect of consistency of the signals. If the signals correspond, everything is in order; if not, a fault message is output.

In order to meet certain safety standards (for example SIL II or SIL III), safety relays 15 of this kind can also be prescribed.

However, neither the provision of a safety relay 15 or a load measuring pin 7 is absolutely necessary for technical functioning of the braking system according to the invention.

In the arrangement described above, the encoders 11a, 11b together with the load measuring pins 7 form a sensor arrangement, which is designed to determine a state of the drive unit, having at least one relevant sensor unit (here the encoders and the load measuring pins), which provides a corresponding sensor signal (here said measurement signals) to the controller 12.

In the configuration of the braking system 3 according to the invention shown, two emergency brakes 16a, 16b are arranged on the cable drum 6, the two emergency brakes preferably having different strengths, that is to say being designed to generate braking forces of different strengths on the cable drum 6. The two emergency brakes 16a, 16b are in the form of hydraulically ventilated brakes and are each operatively connected to a hydraulic pressure unit (hydraulic assembly) 18 via a valve means or switching valve designed as a 2/2-way poppet valve 17. In this case, said valves 17 have a latching function, which can be (electrically) pilot-controlled by the controller 12 by means of a corresponding control signal SS, so that, when the braking system 3 or the emergency brakes 16a, 16b are activated, these brakes are actuated by the controller 12 only according to the pilot control. This can include only one of the two emergency brakes 16a, 16b selectively being actuated. As an alternative, said pilot control can however also have the effect that both emergency brakes 16a, 16b are activated together, in order to achieve a more powerful braking effect. The invention is in no way limited to a certain number of emergency brakes in this context.

As an alternative, design of the brakes as pneumatically ventilated brakes is possible, these brakes then being accordingly operatively connected to a pneumatic pressure unit. Such brakes and the actuation of such brakes are known to a person skilled in the art, in principle.

The pilot control of the emergency brakes 16a, 16b by the controller 12 already mentioned several times is accordingly performed by said measurement signals MS1 to MS4, which indicate an operating state of the crane 1 with respect to the load 2, that is to say the weight and the movement state of said load. In this way, in particular, the braking effect can be increased in a targeted manner if a relatively large load 2 is moved at a relatively high speed. In contrast, the braking effect can be reduced in a targeted manner if the load 2 is only relatively small or if the load 2 is moved only at a relatively low speed. In this way, despite adequate safety in the event of an emergency, in particular harmful effects on said supporting structure 4 of the crane 1 can be reduced.

The controller 12 is operatively connected in a signal-transmitting manner to the at least one sensor unit or the shown sensor units (reference signs 7, 11a, 11b) and designed to preselect and accordingly pilot-control a number of brakes from amongst said plurality of brakes 16a, 16b depending on the relevant sensor signal or the relevant sensor signals, so that, when the braking system 3 is activated, the drive unit can be acted on only by this preselected number of brakes 16a, 16b.

Here, in particular, the encoders 11a, 11b are used to monitor the braking effect. In the event of a deviation in the actual braking effect from a value provided by the controller 12, the controller 12 can respond by way of preventing presetting of the valves 17 in order to adapt the braking force. The greater the number of different emergency brakes 16a, 16b, the more finely stepped the variation in the braking force can be.

In this context, the invention is no way restricted to using hydraulically ventilated brakes—any other type of controllable brakes, especially including pneumatically ventilated brakes, can likewise be used in principle.

According to the illustration or the refinement in FIG. 1, the emergency brakes 16a, 16b are pilot-controlled only on the output side of the transmission 9—not on the output side of the motor 8 in the case of the (service) brake mentioned further above. Such a refinement has proven particularly advantageous from the point of view of the applicant. However, the present invention also comprises, in principle, refinements in which, as an alternative or in addition, motor-side braking according to the brake 10 can be included in the pilot control. To this end, it is in principle only necessary to form the corresponding brakes to be controllable and to connect them in a signal-transmitting manner to the controller 12 in a suitable way. However, this is not described any further here or below.

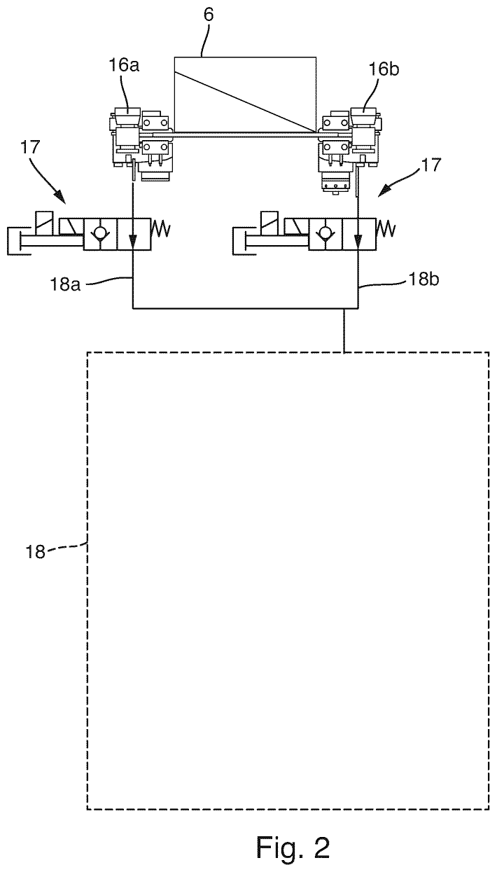

FIG. 2 shows individual elements of the braking system 3 from FIG. 1 in detail. These elements are the cable drum 6 and also the emergency brakes 16a, 16b together with the associated valves 17 and the hydraulic assembly 18, but the exact configuration of this hydraulic assembly is not discussed further in the present case. It is only noted here that the hydraulic assembly 18 can also include at least one 2/2-way poppet valve which is responsible for returning the hydraulic fluid to a tank (not shown) provided for it. However, this valve is generally not actuated via the controller 12, but rather via a special unit (likewise not shown).

FIG. 2 shows the abovementioned valves 17 more precisely in their preferred configuration as 2/2-way poppet valves with a latching function.

The emergency brakes 16a, 16b are—as already mentioned—preferably spring-actuated, hydraulically ventilated brakes on the cable drum 6, which are arranged on the transmission output side. These brakes 16a, 16b preferably have different contact-pressure or braking forces X, Y, to which reference has likewise already been made. The brakes are preselected by the controller 12 (see FIG. 1). In this way, a total of three different braking forces can be realized with two brakes: only the one brake with braking force X; only the other brake with braking force Y; or both brakes with braking force X+Y.

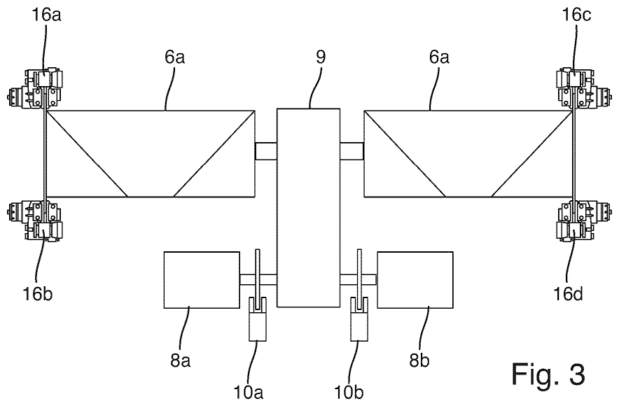

A redundant design of the braking system is also possible and will be explained more precisely with reference to following FIG. 3.

In principle, the choice of the hydraulic assembly 18 used has no influence on the system according to the invention per se. The invention can be realized with any (commercially available) hydraulic assembly in principle. The hydraulic assembly 18 is therefore shown merely as a dashed-line rectangle or blackbox in FIG. 2.

The controllable, especially lockable valves 18 are switched between the respective emergency brake 16a, 16b and an associated hydraulic fluid feed line or discharge line 18a, 18b according to the illustration in FIG. 1 and FIG. 2 and thus are generally themselves not constituent parts of the hydraulic assembly 18. However, as an alternative, they can also be arranged on or even in the hydraulic assembly 18.

However, in principle: the valves 17 are actuated directly by the controller 12 (see FIG. 1) and age independently of any control commands from a controller (not shown) of the hydraulic assembly 18.

Finally, FIG. 3 partially shows a redundant configuration of the braking system 3 according to the invention, in which a total of four hydraulic, that is to say once again spring-actuated and hydraulically ventilated, emergency brakes 16a to 16d are present, in each case two of which (16a, 16c and, respectively, 16b, 16d) apply the same braking force X and, respectively, Y. The following braking forces can preferably be achieved using such a system: if only the brakes with braking force X are activated, the total braking force is 2X; if only the brakes with braking force Y are activated, the total braking force is 2Y; if all the brakes with braking force X and braking force Y are activated, the total braking force is 2X+2Y. In the case of such a design, it is also possible, in principle, to activate only one brake with braking force X, only one brake with braking force Y or else several brakes with a total braking force X+Y, 2X+Y or X+2Y. However, this would be quite impractical in practice because it would result in highly asymmetrical braking. The braking system 3 according to FIG. 3 accordingly also comprises two cable drums 6a, 6b, which are driven by means of two motors 8a, 8b via a common transmission 9. Analogously to the illustration in FIG. 1, a respective (service) brake 10a, 10b is arranged between each of the motors 8a, 8b and the transmission 9, but these brakes 10a, 10b are not pilot-controlled in the illustrated configuration. The brakes 16a and 16b act on the cable drum 6a, while the brakes 16c and 16d act on the cable drum 6b.

One possible application of the present invention relates, in addition to the crane shown in FIG. 1, for example to what are known as gantry cranes, in which two cable drums (see reference signs 6a, 6b in FIG. 3) are driven synchronously. Each cable drum 6a, 6b is then equipped with its own hydraulic brakes 16a, 16b and, respectively, 16c 16d, as illustrated.

1. A braking system (3) in a drive unit, which drive unit comprises at least one motor (8; 8a, 8b) and at least one driven unit (6; 6a, 6b) that is driven by the motor (8; 8a, 8b), the braking system comprising:
a plurality of controllable brakes (16a-16d), which are arranged and designed to act on the drive unit, wherein at least one of the brakes (16a-16d) is operatively connected to a pilot-controllable valve (17);
a controller (12), which is designed to actuate the brakes (16a-16d) in accordance with pilot control of the valve (17) depending on a state or load situation of the drive unit;
the valve (17) has a latching function; and
the latching function of the valve (17) is adapted to be pilot-controlled by the controller (12), so that a number of the brakes (16a-16d) from amongst said plurality of brakes (16a-16d) is preselected, so that, when the braking system (3) is activated, the drive unit is adapted to be acted on only by way of said preselected number of brakes (16a-16d).

2. The braking system (3) as claimed in claim 1, further comprising a sensor arrangement, which is designed to determine the state or load situation of the drive unit, having at least one sensor (7; 11a, 11b), which provides a corresponding sensor signal (MS1-MS4); and the controller (12) is operatively connected in a signal-transmitting manner to the at least one sensor (7; 11a, 11b) and the load situation of the drive unit is adapted to be determined depending on the sensor signal (MS1-MS4).

3. The braking system (3) as claimed in claim 1, wherein the drive unit has a transmission (9), which is operatively connected to the motor (8; 8a, 8b), and the at least one driven unit (6; 6a, 6b) is arranged on an output side of the transmission (9).

4. The braking system (3) as claimed in claim 1, wherein the brakes (16a-16d) are designed and arranged to act on the at least one driven unit (6; 6a, 6b).

5. The braking system (3) as claimed in claim 1, wherein the preselected number comprises at least one brake (16a-16d), a subgroup of all of the brakes (16a-16d), or all the brakes (16a-16d).

6. The braking system (3) as claimed in claim 1, wherein the determined state of the drive system includes at least one of the following variables: a state of the motor (8; 8a, 8b), a rotational speed of the motor (8; 8a, b), a speed of the at least one driven unit (6; 6a, 6b), a travel speed of the at least one driven unit (6; 6a, 6b), or a load (2) acting on the at least one driven unit (6; 6a, 6b) or transported by the at least one driven unit (6; 6a, 6b).

7. The braking system (3) as claimed in claim 2, wherein the drive unit has a transmission (9), which is operatively connected to the motor (8; 8a, 8b), and the at least one driven unit (6; 6a, 6b) is arranged on an output side of the transmission (9), and the at least one sensor comprises an encoder (11a, 11b) arranged on at least one of the motor (8; 8a, b), the at least one driven unit (6; 6a, 6b), or the transmission (9).

8. The braking system (3) as claimed in claim 1, wherein the at least one driven unit comprises a cable winch or a cable drum (6; 6a, 6b) with a cable (5) which is wound or adapted to be wound thereon.

9. The braking system (3) as claimed in claim 18, wherein the load measuring pin (7) is operatively connected to the cable (5).

10. The braking system (3) as claimed in claim 1, wherein at least one of the brakes (16a-16d) comprises a hydraulically actuable brake (16a-16d).

11. (canceled)

12. (canceled)

13. The braking system (3) as claimed in claim 1, wherein the valve (17) is a 2/2-way valve.

14. The braking system (3) as claimed in claim 1, wherein at least some of the brakes (16a-16d) are designed to generate different contact-pressure forces or braking forces (X, Y).

15. A crane (1) or gantry crane comprising the braking system (3) as claimed in claim 1.

16. A method for braking with variable braking force in a drive unit, said drive unit comprises at least one motor (8; 8a, 8b) and at least one unit (6; 6a, 6b) driven by the motor (8; 8a, 8b), the method comprising:
a) providing a braking system (3) having a plurality of controllable brakes (16a-16d), which are arranged and designed to act on the drive unit;
b) determining a state or load situation of the drive unit; and
c) making a preselection of a variable number of the brakes (16a-16d), the number being dependent on the determined state or load situation, from said plurality of brakes (16a-16b) by a controller (12) depending on the determined state or load situation, which preselection, based on a corresponding pilot control of the brakes (16a-16d), has the effect that, when the braking system (3) is activated, the drive unit is adapted to be acted on only by way of said preselected number of the brakes (16a-16d).

17. The method as claimed in claim 16, further comprising determining the state or load situation by a sensor arrangement having at least one sensor (7; 11a, 11b), which provides a corresponding sensor signal (MS1-MS4), with the controller (12) being operatively connected in a signal-transmitting manner to the sensor (7; 11a, 11b).

18. The braking system (3) as claimed in claim 2, wherein the sensor comprises a load measuring pin (7).

19. The braking system (3) as claimed in claim 10, wherein the hydraulically actuable brake is a spring-actuated, hydraulically ventilated brake (16a-16d).
